(19) United States
(12) Patent Application Publication
(10) Pub. No.: US 2024/0251722 A1
(43) Pub. Date: Aug. 1, 2024

(54) Vacuum-Mulching Device

(71) Applicant: Jeremy Duncan, Williamsburg, OH (US)

(72) Inventor: Jeremy Duncan, Williamsburg, OH (US)

(21) Appl. No.: 18/412,104

(22) Filed: Jan. 12, 2024

Related U.S. Application Data
(60) Provisional application No. 63/441,263, filed on Jan. 26, 2023.

(51) Int. Cl. A01G 20/47; B02C 23/02; B02C 23/24

(52) U.S. Cl. CPC A01G 20/47; B02C 23/02; B02C 23/24

(57) ABSTRACT

A vacuum-mulching device is provided. The device is comprised of body-worn housing. The housing is comprised of a vacuum motor that allows a user to vacuum outdoor debris into the housing via at least one arm. In one embodiment, the housing is also comprised of a mulching assembly that mulches debris vacuumed into the housing. In one embodiment, the mulched debris can be expelled from the housing. In another embodiment, the mulched debris can be stored within a removable container in the housing that can be removed to dispose of the debris.

### CROSS-REFERENCE TO RELATED APPLICATION

The present application claims priority to, and the benefit of, U.S. Provisional Application No. 63/441,263, which was filed on Jan. 26, 2023, and is incorporated herein by reference in its entirety.

### FIELD OF THE INVENTION

The present invention relates generally to the field of lawn devices. More specifically, the present invention relates to a body-worn device that allows a user to vacuum and/or mulch outdoor debris that can be collected within the device in one embodiment. Accordingly, the present disclosure makes specific reference thereto. Nonetheless, it is to be appreciated that aspects of the present invention are also equally applicable to other like applications, devices, and methods of manufacture.

### BACKGROUND

A variety of natural debris such as leaves, twigs, grass clippings, and other organic matter often accumulate in outdoor areas around properties. This accumulation not only detracts from the aesthetic appeal of the landscape but can also pose a nuisance for property owners. To tackle this issue, individuals commonly resort to using tools like leaf blowers and rakes to displace the debris. Then, the materials must be collected in trash bags for disposal, which can be both frustrating and time-consuming.

Furthermore, if these debris is not regularly managed, it can lead to a significant buildup, making yards, gardens, or sidewalks appear unkempt and neglected. This can also potentially lead to issues with pest control and drainage, as excessive debris may create habitats for pests or block water pathways. Thus, maintaining a clean and tidy outdoor space is thus not only important for aesthetic reasons but also for the overall health and functionality of the property.

Therefore, there exists a long-felt need in the art for a device that can be used to clean an outdoor area of a property. There also exists a long-felt need in the art for a vacuum-mulching device. There also exists a long-felt need in the art for a vacuum-mulching device that allows a user to vacuum outdoor debris. Further, there exists a long-felt need in the art for a vacuum-mulching device that allows a user to mulch outdoor debris. In addition, there exists a long-felt need in the art for a vacuum-mulching device that allows a user to collect outdoor debris for disposal.

The subject matter disclosed and claimed herein, in one embodiment thereof, comprises a vacuum-mulching device. The device is comprised of body-worn housing. The housing is comprised of a vacuum motor that allows a user to vacuum outdoor debris into the housing via at least one arm. In one embodiment, the housing is also comprised of a mulching assembly that mulches debris vacuumed into the housing. In one embodiment, the mulched debris can be expelled from the housing. In another embodiment, the mulched debris can be stored within a removable container in the housing that can be removed to dispose of the debris.

In this manner, the vacuum-mulching device of the present invention accomplishes all the forgoing objectives and provides a device that can be used to clean an outdoor area of a property. More specifically, the device allows a user to vacuum and/or mulch outdoor debris. Further, the device allows a user to collect outdoor debris for disposal.

### SUMMARY

The following presents a simplified summary to provide a basic understanding of some aspects of the disclosed innovation. This summary is not an extensive overview, and it is not intended to identify key/critical elements or to delineate the scope thereof. Its sole purpose is to present some general concepts in a simplified form as a prelude to the more detailed description that is presented later.

The subject matter disclosed and claimed herein, in one embodiment thereof, comprises a vacuum-mulching device designed to be used in order to allow a user to vacuum and container and/or mulch various debris such as but not limited to leaves, twigs, grass clippings, etc.

The device is comprised of at least one housing. The housing is worn on a user's back via at least one strap. The device is comprised of at least one vacuum motor. The motor creates vacuum suction that allows debris to be sucked through at least one opening of at least one arm connected to the housing via at least one flexible or non-flexible tubing.

The housing is also comprised of at least one mulching assembly within the housing. The mulching assembly may be comprised of at least one mulching blade or other similar mulching structure of the like that may be powered by (and spun by) the motor (or a separate motor). As a result, debris sucked into the housing is mulched by the mulching assembly.

The housing may be comprised of at least one opening that allows mulched material to be blown out of the housing via the motor. In an embodiment wherein a user desires to collect the mulched material, the opening can be covered via at least one cap. In this embodiment, the housing is comprised of at least one storage container that is detachably attached to the housing via at least one fastener (such as but not limited to a latch, a clip, a magnet, etc.). In this manner, mulched (or non-mulched) debris collected within the housing during use of the device can be removed from the housing via the container (and then disposed of).

The present invention is also comprised of a method of using the device. First, a device is provided comprised of a housing comprised of at least one motor, at least one mulching assembly, at least one strap, and at least one arm comprised of at least one opening. In an embodiment wherein the housing is comprised of at least one opening, at least one cap can be removed from the opening to allow mulched debris to exit the housing. Then, a user can place the housing onto their back via the strap. Next, a user can press a button of the device to activate the motor and/or mulching assembly. Next, the user can use the arm to suck up debris into the housing.

The present invention is also comprised of a second method of using the device. First, a device is provided comprised of a housing comprised of at least one motor, at least one mulching assembly, at least one strap, at least one arm comprised of at least one opening, and at least one storage container removably attached to the housing. Then, a user can place the housing onto their back via the strap. Next, a user can press a button of the device to activate the motor and/or mulching assembly. Next, the user can use the arm to suck up debris into the housing. Once the debris has been collected in the storage container of the housing, the container can be removed from the housing (via unfastening at least one fastener that secures the container to the housing) and any debris within the container can be disposed of in a secondary area/location.

Accordingly, the vacuum-mulching device of the present invention is particularly advantageous as it provides a device that can be used to clean an outdoor area of a property. More specifically, the device allows a user to vacuum and/or mulch outdoor debris. Further, the device allows a user to collect outdoor debris for disposal. In this manner, the vacuum-mulching device overcomes the limitations of existing devices and methods known in the art for outdoor cleaning.

To the accomplishment of the foregoing and related ends, certain illustrative aspects of the disclosed innovation are described herein in connection with the following description and the annexed drawings. These aspects are indicative, however, of but a few of the various ways in which the principles disclosed herein can be employed and are intended to include all such aspects and their equivalents. Other advantages and novel features will become apparent from the following detailed description when considered in conjunction with the drawings.

### BRIEF DESCRIPTION OF THE DRAWINGS

The description refers to provided drawings in which similar reference characters refer to similar parts throughout the different views, and in which:

FIG. 1 illustrates a rear perspective view of one potential embodiment of a vacuum-mulching device of the present invention while worn by a user in accordance with the disclosed architecture;

FIG. 2 illustrates a front perspective view of one potential embodiment of a vacuum-mulching device of the present invention while worn by a user in accordance with the disclosed architecture;

FIG. 3 illustrates an enhanced perspective view of a handle of one potential embodiment of a vacuum-mulching device of the present invention while worn by a user in accordance with the disclosed architecture;

FIG. 4 illustrates a flowchart of a method of using one potential embodiment of a vacuum-mulching device of the present invention in accordance with the disclosed architecture; and

FIG. 5 illustrates a flowchart of a method of using one potential embodiment of a vacuum-mulching device of the present invention in accordance with the disclosed architecture.

### DETAILED DESCRIPTION

The innovation is now described with reference to the drawings, wherein like reference numerals are used to refer to like elements throughout. In the following description, for purposes of explanation, numerous specific details are set forth to provide a thorough understanding thereof. It may be evident, however, that the innovation can be practiced without these specific details. In other instances, well-known structures and devices are shown in block diagram form to facilitate a description thereof. Various embodiments are discussed hereinafter. It should be noted that the figures are described only to facilitate the description of the embodiments. They are not intended as an exhaustive description of the invention and do not limit the scope of the invention. Additionally, an illustrated embodiment need not have all the aspects or advantages shown. Thus, in other embodiments, any of the features described herein from different embodiments may be combined.

As noted above, there exists a long-felt need in the art for a device that can be used to clean an outdoor area of a property. There also exists a long-felt need in the art for a vacuum-mulching device. There also exists a long-felt need in the art for a vacuum-mulching device that allows a user to vacuum outdoor debris. Further, there exists a long-felt need in the art for a vacuum-mulching device that allows a user to mulch outdoor debris. In addition, there exists a long-felt need in the art for a vacuum-mulching device that allows a user to collect outdoor debris for disposal.

The present invention, in one exemplary embodiment, is comprised of a vacuum-mulching device. The device is designed to be used in order to allow a user to vacuum and container and/or mulch various debris such as but not limited to leaves, twigs, grass clippings, etc.

The device is comprised of at least one housing worn on a user's back via at least one strap. The device is comprised of at least one vacuum motor that creates vacuum suction that allows debris to be sucked through at least one opening of at least one arm connected to the housing via at least one flexible or non-flexible tubing. The housing is also comprised of at least one mulching assembly within the housing that may be comprised of at least one mulching blade or other similar mulching structure of the like that may be powered by (and spun by) the motor (or a separate motor). As a result, debris sucked into the housing is mulched by the mulching assembly.

The housing may be comprised of at least one opening that allows mulched material to be blown out of the housing via the motor. In an embodiment wherein a user desires to collect the mulched material, the opening can be covered via at least one cap. In this embodiment, the housing is comprised of at least one storage container that is detachably attached to the housing via at least one fastener (such as but not limited to a latch, a clip, a magnet, etc.). In this manner, mulched (or non-mulched) debris collected within the housing during use of the device can be removed from the housing via the container (and then disposed of).

The present invention is also comprised of a method of using the device. First, a device is provided comprised of a housing comprised of at least one motor, at least one mulching assembly, at least one strap, and at least one arm comprised of at least one opening. In an embodiment wherein the housing is comprised of at least one opening, at least one cap can be removed from the opening to allow mulched debris to exit the housing. Then, a user can place the housing onto their back via the strap. Next, a user can press a button of the device to activate the motor and/or mulching assembly. Next, the user can use the arm to suck up debris into the housing.

The present invention is also comprised of a second method of using the device. First, a device is provided comprised of a housing comprised of at least one motor, at least one mulching assembly, at least one strap, at least one arm comprised of at least one opening, and at least one storage container removably attached to the housing. Then, a user can place the housing onto their back via the strap. Next, a user can press a button of the device to activate the motor and/or mulching assembly. Next, the user can use the arm to suck up debris into the housing. Once the debris has been collected in the storage container of the housing, the container can be removed from the housing (via unfastening at least one fastener that secures the container to the housing) and any debris within the container can be disposed of in a secondary area/location.

Accordingly, the vacuum-mulching device of the present invention is particularly advantageous as it provides a device that can be used to clean an outdoor area of a property. More specifically, the device allows a user to vacuum and/or mulch outdoor debris. Further, the device allows a user to collect outdoor debris for disposal. In this manner, the vacuum-mulching device overcomes the limitations of existing devices and methods known in the art for outdoor cleaning.

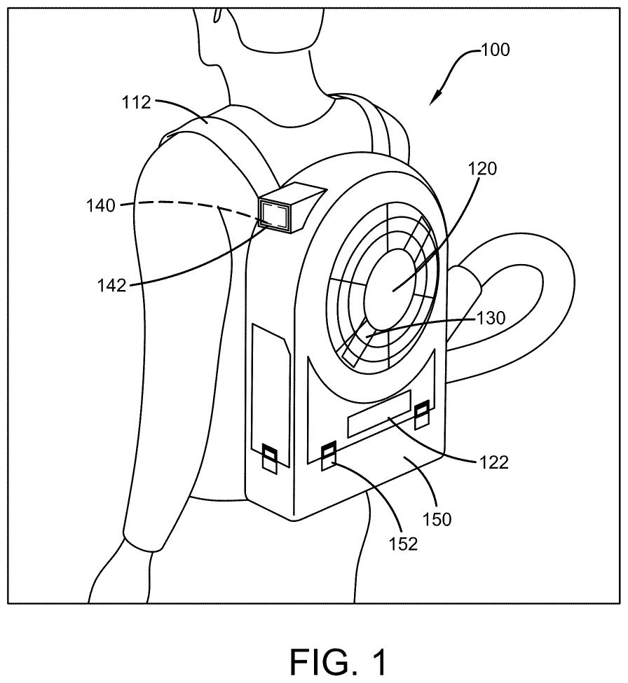

Referring initially to the drawings, FIG. 1 illustrates a rear perspective view of one potential embodiment of a vacuum-mulching device 100 of the present invention while worn by a user in accordance with the disclosed architecture. The device 100 is designed to be used in order to allow a user to vacuum and container and/or mulch various debris such as but not limited to leaves, twigs, grass clippings, etc.

The device 100 is comprised of at least one housing 110. The housing 110 is worn on a user's back via at least one strap 112. The strap 112 may be fixed or adjustable in different embodiments. The strap 112 may also be padded for comfort.

The device 100 is comprised of at least one vacuum motor 120. The motor 120 may be a gas/diesel motor in one embodiment. In another embodiment, the motor 120 is electric and is powered by at least one battery 122. The battery 122 may be removable or non-removable from the housing 110 and/or motor 120. The battery 122 may also be rechargeable or disposable.

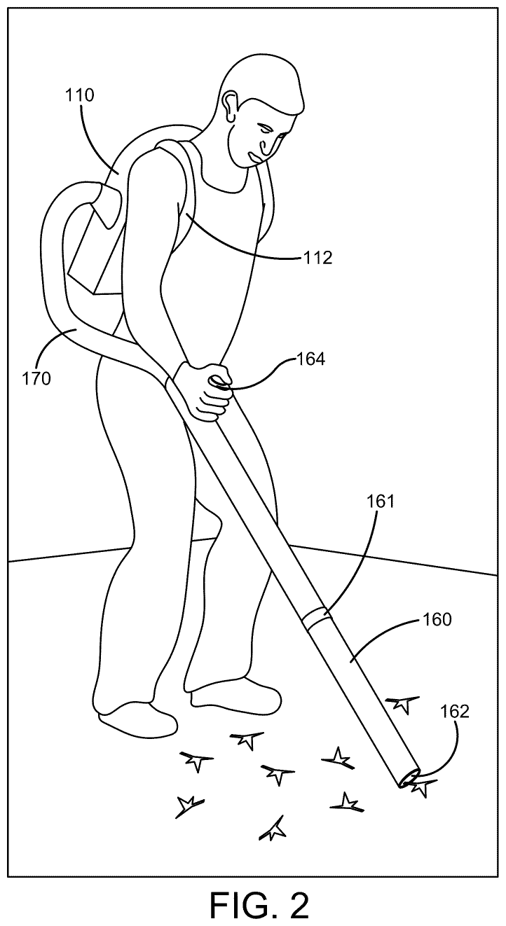

The motor 120 creates vacuum suction that allows debris to be sucked through at least one opening 162 of at least one arm 160 connected to the housing 110 via at least one flexible or non-flexible tubing 170, as seen in FIG. 2. The arm 160 may be of a fixed length or telescopic. In a telescopic embodiment, the arm 160 is comprised of at least one locking member 161 (of any type) that allows the arm 160 to be locked at a desired length. The arm 160 may also be comprised of at least one handle 164 of any handle style and configuration.

The housing 110 is also comprised of at least one mulching assembly 130 within the housing 110. The mulching assembly 130 may be comprised of at least one mulching blade or other similar mulching structure of the like that may be powered by (and spun by) the motor 120 (or a separate motor). As a result, debris sucked into the housing 110 is mulched by the mulching assembly 130.

The housing 110 may be comprised of at least one opening 140 that allows mulched material to be blown out of the housing 110 via the motor. In an embodiment wherein a user desires to collect the mulched material, the opening 140 can be covered via at least one cap 142 or similar covering. In this embodiment, the housing 110 is comprised of at least one storage container 150 that is detachably attached to the housing 110 via at least one fastener 152 (such as but not limited to a latch, a clip, a magnet, etc.). In this manner, mulched (or non-mulched) debris collected within the housing 110 during use of the device 100 can be removed from the housing 110 via the container 150 (and then disposed of).

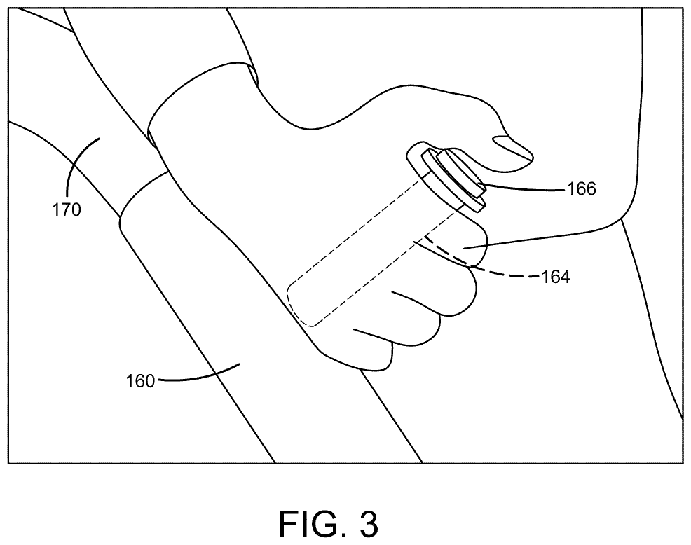

At least one button 166 may be positioned on the handle 164, arm 160, and/or housing 110, as seen in FIG. 3. The button 166 allows a user to turn on the motor 120 and/or mulching assembly 130.

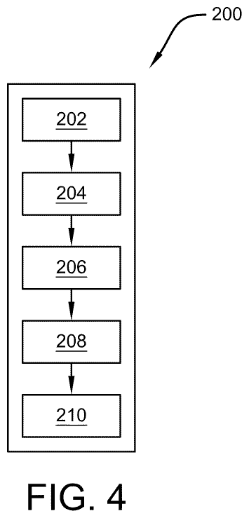

The present invention is also comprised of a method of using 200 the device 100, as seen in FIG. 4. First, a device 100 is provided comprised of a housing 110 comprised of at least one motor 120, at least one mulching assembly 130, at least one strap 112, and at least one arm 160 comprised of at least one opening 162 [Step 202]. In an embodiment wherein the housing 110 is comprised of at least one opening 140, at least one cap 142 can be removed from the opening to allow mulched debris to exit the housing 110 [Step 204]. Then, a user can place the housing 110 onto their back via the strap 112 [Step 206]. Next, a user can press a button 166 of the device 100 to activate the motor 120 and/or mulching assembly 130 [Step 208]. Next, the user can use the arm 160 to suck up debris into the housing [Step 210].

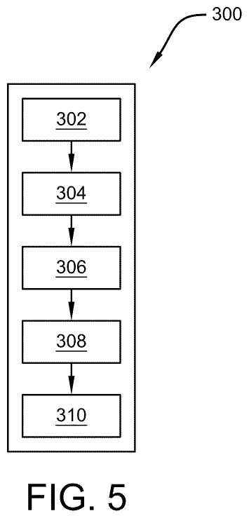

The present invention is also comprised of a second method of using 300 the device 100, as seen in FIG. 5. First, a device 100 is provided comprised of a housing 110 comprised of at least one motor 120, at least one mulching assembly 130, at least one strap 112, at least one arm 160 comprised of at least one opening 162, and at least one storage container 150 removably attached to the housing 110 [Step 302]. Then, a user can place the housing 110 onto their back via the strap 112 [Step 304]. Next, a user can press a button 166 of the device 100 to activate the motor 120 and/or mulching assembly 130 [Step 306]. Next, the user can use the arm 160 to suck up debris into the housing [Step 308]. Once the debris has been collected in the storage container 150 of the housing 110, the container 150 can be removed from the housing 110 (via unfastening at least one fastener 152 that secures the container 150 to the housing 110) and any debris within the container 150 can be disposed of in a secondary area/location [Step 310].

Certain terms are used throughout the following description and claims to refer to particular features or components. As one skilled in the art will appreciate, different persons may refer to the same feature or component by different names. This document does not intend to distinguish between components or features that differ in name but not structure or function. As used herein “vacuum-mulching device” and “device” are interchangeable and refer to the vacuum-mulching device 100 of the present invention.

Notwithstanding the forgoing, the vacuum-mulching device 100 of the present invention and its various components can be of any suitable size and configuration as is known in the art without affecting the overall concept of the invention, provided that they accomplish the above-stated objectives. One of ordinary skill in the art will appreciate that the size, configuration, and material of the vacuum-mulching device 100 as shown in the FIGS. are for illustrative purposes only, and that many other sizes and shapes of the vacuum-mulching device 100 are well within the scope of the present disclosure. Although the dimensions of the vacuum-mulching device 100 are important design parameters for user convenience, the vacuum-mulching device 100 may be of any size, shape, and/or configuration that ensures optimal performance during use and/or that suits the user's needs and/or preferences.

Various modifications and additions can be made to the exemplary embodiments discussed without departing from the scope of the present invention. While the embodiments described above refer to particular features, the scope of this invention also includes embodiments having different combinations of features and embodiments that do not include all the described features. Accordingly, the scope of the present invention is intended to embrace all such alternatives, modifications, and variations as fall within the scope of the claims, together with all equivalents thereof.

What has been described above includes examples of the claimed subject matter. It is, of course, not possible to describe every conceivable combination of components or methodologies for purposes of describing the claimed subject matter, but one of ordinary skill in the art may recognize that many further combinations and permutations of the claimed subject matter are possible. Accordingly, the claimed subject matter is intended to embrace all such alterations, modifications, and variations that fall within the spirit and scope of the appended claims. Furthermore, to the extent that the term “includes” is used in either the detailed description or the claims, such term is intended to be inclusive in a manner similar to the term “comprising” as “comprising” is interpreted when employed as a transitional word in a claim.

What is claimed is:

1. A vacuum-mulching device comprising:
a housing comprised of a strap, a motor, a dispenser opening, and a mulching assembly;
an arm connected to the housing, the arm comprised of an opening; and
a cap.

2. The vacuum-mulching device of claim 1, wherein the strap is comprised of an adjustable strap.

3. The vacuum-mulching device of claim 1, wherein the motor is comprised of a gas vacuum motor or an electric vacuum motor.

4. The vacuum-mulching device of claim 1 further comprised of a battery.

5. The vacuum-mulching device of claim 1, wherein the arm is comprised of a telescopic arm.

6. The vacuum-mulching device of claim 1, wherein the arm is comprised of a handle.

7. The vacuum-mulching device of claim 1, wherein the mulching assembly is comprised of a blade.

8. The vacuum-mulching device of claim 7, wherein the blade is spun by the motor.

9. A vacuum-mulching device comprising:
a housing comprised of a strap, a storage container attached to the housing via a fastener, a motor, and a mulching assembly; and
an arm connected to the housing, the arm comprised of an opening.

10. The vacuum-mulching device of claim 9, wherein the strap is comprised of an adjustable strap.

11. The vacuum-mulching device of claim 9, wherein the motor is comprised of a gas vacuum motor or an electric vacuum motor.

12. The vacuum-mulching device of claim 9 further comprised of a battery.

13. The vacuum-mulching device of claim 9, wherein the arm is comprised of a telescopic arm.

14. The vacuum-mulching device of claim 9, wherein the arm is comprised of a handle.

15. The vacuum-mulching device of claim 9, wherein the mulching assembly is comprised of a blade.

16. The vacuum-mulching device of claim 15, wherein the blade is spun by the motor.

17. The vacuum-mulching device of claim 9, wherein the storage container is removable from the housing.

18. The vacuum-mulching device of claim 9, wherein the fastener is comprised of a clip.

19. A method of using a vacuum-mulching device, the method comprising the following steps:
providing a vacuum-mulching device comprised of a housing comprised of a motor, a mulching assembly, a strap, and an arm comprised of an opening;
placing the housing onto a user's back via the strap;
pressing a button of the vacuum-mulching device to activate the motor; and
using the arm to suck up debris into the housing.

20. The method of using a vacuum-mulching device of claim 19 further comprised of a step of pressing the button of the vacuum-mulching device to activate the mulching assembly.
